(19) United States
(12) Patent Application Publication
(10) Pub. No.: US 2025/0273411 A1
(43) Pub. Date: Aug. 28, 2025

(54) MAGNETIC ACTUATOR

(71) Applicant: G & W Electric Company, Bolingbrook, IL (US)

(72) Inventors: Nenad Uzelac, St. John, IN (US); Milos Stojkovic, Nis (RS)

(21) Appl. No.: 19/061,810

(22) Filed: Feb. 24, 2025

Related U.S. Application Data
(60) Provisional application No. 63/557,060, filed on Feb. 23, 2024.

(51) Int. Cl. H01H 3/26

(52) U.S. Cl. CPC H01H 3/26

(57) ABSTRACT

A magnetic actuator may include a stator supporting a plurality of permanent magnets and a coil. The magnetic actuator may further include a plunger assembly movable along an axis relative to the stator between a first position and a second position in response to energizing the coil. The plunger assembly may be configured to move at least 1.0 cm along the axis between the first position and the second position in 6 ms or less in response to energizing the coil.

### CROSS-REFERENCE TO RELATED APPLICATIONS

This application claims priority to U.S. Provisional Patent Application No. 63/557,060, filed Feb. 23, 2024, the entire content of which is incorporated herein by reference.

### FIELD

The present invention relates to magnetic actuators for electrical switchgear.

### BACKGROUND

Electrical switchgear may include a movable contact that is movable between an open position and a closed position. Electrical switchgear used in power transmission and distribution systems may be energized with relatively high voltage, such as 15.5 kV, 27 kV, 38 kV, 72.5 kV, etc.

### SUMMARY

When the electrical switchgear is energized and the contacts are separated, arcing may occur between the contacts during the initial moments of separation. It is desirable to separate the contacts as quickly as possible to minimize arcing. It is also desirable to separate the contacts as quickly as possible to stop the flow of electrical current through the switchgear in response to a detected fault. By stopping the flow of electrical current quickly in response to a fault, adverse effects of the fault on electrical equipment and property may be minimized.

Thus, a need exists for an actuator for electrical switchgear that can separate the contacts more quickly than known actuators.

In some aspects, the techniques described herein relate to a magnetic actuator for a switchgear system, the magnetic actuator including: a stator supporting a plurality of permanent magnets and a coil; and a plunger assembly movable along an axis relative to the stator between a first position and a second position in response to energizing the coil, wherein the plunger assembly is configured to move at least 1.0 cm along the axis between the first position and the second position in 6 ms or less in response to energizing the coil.

In some aspects, the techniques described herein relate to a magnetic actuator, wherein the stator includes a cylindrical frame.

In some aspects, the techniques described herein relate to a magnetic actuator, wherein the plunger assembly includes a shaft extending along the axis and a plunger body fixed to the shaft, and wherein the plunger body has a mass less than 1 kg.

In some aspects, the techniques described herein relate to a magnetic actuator, wherein the plunger body includes a tapered portion.

In some aspects, the techniques described herein relate to a magnetic actuator, wherein the plunger body includes a first end, a second end opposite the first end, a first portion extending from the first end, and a second portion extending from the second end, wherein the first portion includes the tapered portion, and wherein the second portion is cylindrical.

In some aspects, the techniques described herein relate to a magnetic actuator, wherein the plunger body includes a third portion between the first portion and the second portion, wherein the third portion is cylindrical, and wherein an outer diameter of the third portion is greater than an outer diameter of the second portion to define a lip.

In some aspects, the techniques described herein relate to a magnetic actuator, wherein the first end of the plunger body engages the stator when the plunger assembly is in the first position, and wherein the lip engages the stator when the plunger assembly is in the second position.

In some aspects, the techniques described herein relate to a magnetic actuator, further including a spring biasing the plunger assembly toward the second position.

In some aspects, the techniques described herein relate to a magnetic actuator, wherein the spring has a spring constant of at least 30 N/mm.

In some aspects, the techniques described herein relate to a magnetic actuator, wherein the plunger assembly includes a plunger body having a recess, and wherein the spring is received within the recess.

In some aspects, the techniques described herein relate to a magnetic actuator, wherein the recess is tapered.

In some aspects, the techniques described herein relate to a magnetic actuator, wherein the stator includes a frame surrounding the coil, and wherein the frame is cylindrical.

In some aspects, the techniques described herein relate to a magnetic actuator, wherein the coil is a first coil, and wherein the magnetic actuator further includes a second coil supported by the stator.

In some aspects, the techniques described herein relate to a magnetic actuator, further including a spring biasing the plunger assembly in a first direction toward the second position, and wherein the second coil is configured to be energized to produce a force on the plunger assembly in the first direction.

In some aspects, the techniques described herein relate to a magnetic actuator, wherein the first coil and the second coil are configured to be energized to move the plunger assembly from the first position toward the second position.

In some aspects, the techniques described herein relate to a magnetic actuator, wherein the plurality of permanent magnets is configured to retain the plunger assembly in the first position.

In some aspects, the techniques described herein relate to a magnetic actuator for a switchgear system, the magnetic actuator including: a stator supporting a plurality of permanent magnets and a coil; a plunger assembly movable along an axis relative to the stator between a first position and a second position in response to energizing the coil, wherein the plunger assembly includes a shaft extending along the axis and a plunger body fixed to the shaft, the plunger body including a first end, a second end opposite the first end, a first portion extending from the first end, the first portion having a tapered shape, a second portion extending from the second end, the second portion having a cylindrical shape, and a third portion between the first portion and the second portion, wherein the third portion is cylindrical, and wherein an outer diameter of the third portion is greater than an outer diameter of the second portion to define a lip; a spring biasing the plunger assembly in a first direction toward the second position; and a permanent magnet configured to retain the plunger assembly in the first position, wherein the first end of the plunger body engages the stator when the plunger assembly is in the first position, and wherein the lip engages the stator when the plunger assembly is in the second position.

In some aspects, the techniques described herein relate to a magnetic actuator for a switchgear system, the magnetic actuator including: a stator supporting a plurality of permanent magnets, a first coil, and a second coil; a plunger assembly movable along an axis relative to the stator from a first position toward a second position in response to energizing the first coil and the second coil; and a spring configured to bias the plunger assembly toward the second position, wherein the plurality of permanent magnets is configured to retain the plunger assembly in the first position via a magnetic attractive force greater than a biasing force of the spring, and wherein the first coil and the second coil, when energized, produce magnetic forces on the plunger assembly, which, together with the biasing force of the spring, overcome the magnetic attractive force to move the plunger assembly to the second position.

In some aspects, the techniques described herein relate to a magnetic actuator, wherein the stator includes a frame surrounding the first coil, and wherein the frame is cylindrical.

In some aspects, the techniques described herein relate to a magnetic actuator, further including a first end cap coupled to the frame and a second end cap coupled to the frame opposite the first end cap, wherein the second end cap is positioned between the frame and the second end cap.

Other features and aspects of the disclosure will become apparent by consideration of the following detailed description and accompanying drawings.

### BRIEF DESCRIPTION OF THE DRAWINGS

FIG. 1 is a perspective view of a magnetic actuator for a switchgear system according to an embodiment of the present disclosure.

FIG. 2 is a cross-sectional perspective view of the magnetic actuator of FIG. 1 taken along line 2-2 in FIG. 1.

FIG. 3A is a cross-sectional view of the magnetic actuator of FIG. 1 taken along line 3-3 in FIG. 1, showing a first magnetic field generated by an energized first coil.

FIG. 3B is a cross-sectional view of the magnetic actuator of FIG. 1 taken along line 3-3 in FIG. 1, showing a second magnetic field generated by energizing the first coil.

FIG. 4 is a cross-sectional view of the magnetic actuator of FIG. 1, taken along line 2-2 in FIG. 1, showing airflow pathways.

FIG. 5 is a cross-sectional view of the magnetic actuator of FIG. 1, taken along line 5-5 in FIG. 1, showing airflow pathways.

FIG. 6 is a perspective cross-sectional view of a coil of the magnetic actuator of FIG. 1.

FIG. 7 is a perspective cross-sectional view of a plunger body of the magnetic actuator of FIG. 1.

FIG. 8 is a cross-sectional view of the plunger body of the magnetic actuator of FIG. 1.

FIG. 9 is an upper perspective view of an outer portion of a first end cap of a stator of the magnetic actuator of FIG. 1.

FIG. 10 is a lower perspective view of the outer portion of FIG. 9.

FIG. 11 is a perspective view of an inner portion of the first end cap of the stator of the magnetic actuator of FIG. 1.

FIG. 12 is a perspective view of a second end cap of the stator of the magnetic actuator of FIG. 1.

FIG. 13 is a perspective view of a bearing support of the magnetic actuator of FIG. 1.

FIG. 14 is a perspective view of an end plate of the magnetic actuator of FIG. 1.

FIG. 15 is a partial exploded view of the magnetic actuator of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

Also, it is to be understood that the phraseology and terminology used herein is for the purpose of description and should not be regarded as limiting. For example, the use of directional terms such as upper, lower, top, bottom, left, and right are used for descriptive purposes only with reference to the particular orientations illustrated in the figures.

### DETAILED DESCRIPTION

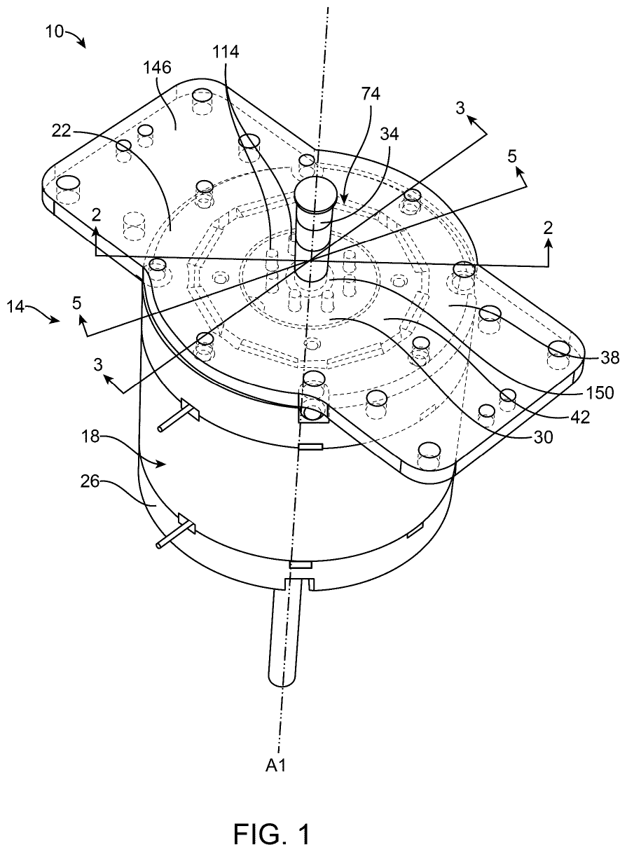

FIG. 1 illustrates a magnetic actuator 10 for a switchgear system according to an embodiment of the present disclosure. The magnetic actuator 10 may be coupled, for example, to a movable contact of a vacuum interrupter or other loadbreak device of the switchgear system, and is operable to move the movable contact between an open position and a closed position.

With continued reference to FIG. 1, the magnetic actuator 10 includes a stator 14 having a cylindrical frame 18, a first end cap 22 positioned on an upper (first) side of the frame 18, and a second end cap 26 positioned on a lower (second) side of the frame 18. The frame 18 defines a first longitudinal axis A1 extending centrally through the frame 18 and the end caps 22, 26.

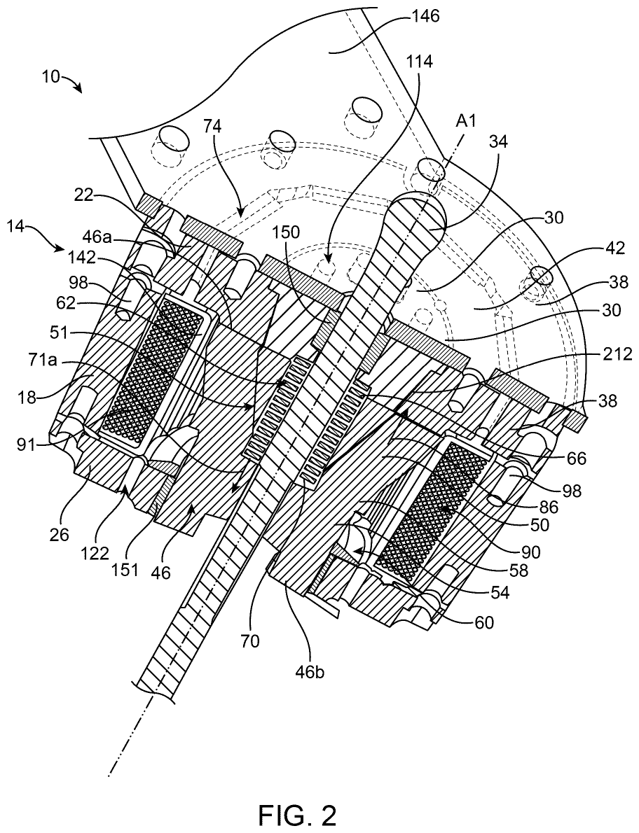

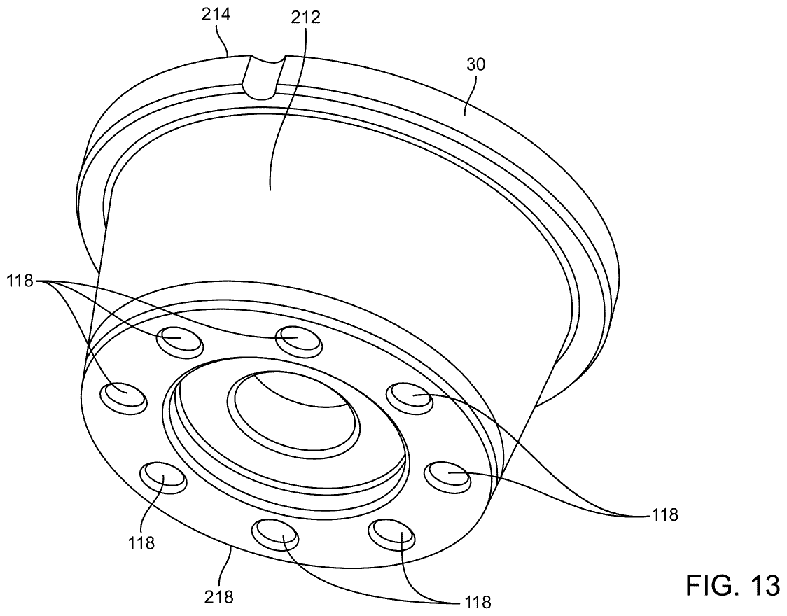

Referring to FIG. 2, the first end cap 22 includes an outer portion 38 and an inner portion 42. The outer portion 38 and the inner portion 42 of the first end cap 22 may be made of a ferromagnetic material, such as steel. A bearing support 30 is received by the inner portion 42. The bearing support 30 may be made of non-magnetic material, such as aluminum. The illustrated bearing support 30 includes a tapered wall 212 that is tapered inwardly in a direction moving from an upper (i.e., first) side 214 of the bearing support 30 toward a lower (i.e., second) side 218 of the bearing support 30 (FIG. 13).

A first linear bearing 150 is positioned within the bearing support 30 to support a shaft 34, such that the shaft 34 is slidable along the axis A1 (FIG. 2). In the illustrated embodiment, the shaft 34 is further supported by a second linear bearing 151, which in turn is supported by the second end cap 26. The linear bearing 150 may be a roller bearing, a bushing, or the like. The shaft 34 is configured to be coupled to the movable contact (e.g., through an insulating operating rod), such that longitudinal motion of the shaft 34 may be transferred to the movable contact to move the contact between the open and closed positions.

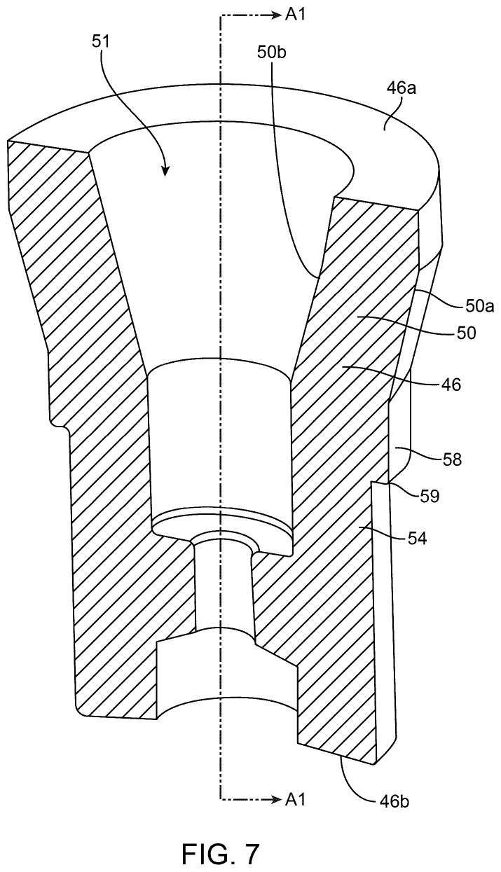

With continued reference to FIG. 2, a plunger body 46 is fixed (e.g., by press-fitting, welding, etc.) to the shaft 34 for movement therewith along the longitudinal axis A1. The plunger body 46 includes a first end 46a closest to and facing the first end cap 22 and a second end 46b opposite the first end 46a. Best illustrated in FIG. 7, a first portion 50 of the plunger body 46 extends from the first end 46a toward the second end 46b, and a second portion 54 extends from the second end 46b toward the first end 46a. In the illustrated embodiment, the first portion 50 is at least partially tapered or frusto-conical, such that at least part of the first portion 50 has an outer surface 50a with an outer diameter that increases in a direction along the longitudinal axis A1 from the second end 46b toward the first end 46a. An inner surface 50b of the first portion 50 is also at least partially tapered or frusto-conical, such that a frusto-conical recess 51 is defined within the first portion 50 of the plunger body 46.

With continued reference to FIG. 7, the second portion 54 of the plunger body 46 is cylindrical in the illustrated embodiment, with an outer diameter that is constant along the longitudinal axis A1. In the illustrated embodiment, the plunger body 46 further includes a third portion 58 between the first portion 50 and the second portion 54. The third portion 58 is cylindrical in the illustrated embodiment, with an outer diameter that is constant along the longitudinal axis A1, but that is larger than the outer diameter of the second portion 54, such that a lip or shoulder 59 is located at an interface between the second portion 54 and the third portion 58. In the illustrated embodiment, the recess 51 also includes a cylindrical portion that extends centrally along the longitudinal axis A1 into the third portion 58 and the second portion 54 of the plunger body 46.

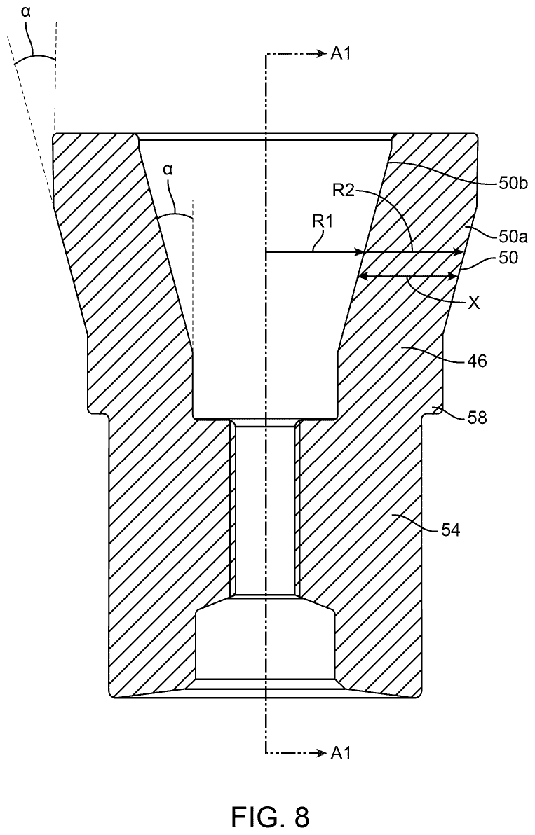

With reference to FIG. 7, the plunger body 46 includes a two-dimensional cross-sectional projection having a geometry that changes as the cross-sectional projection moves along the axis A1. In the illustrated embodiment, the inner surface 50b extends outwardly from the longitudinal axis A1 at a conical angle a of approximately 15 degrees (FIG. 8). In some embodiments, the conical angle a may be between 1 degree and 89 degrees, between 5 degrees and 30 degrees, or the like. The outer surface 50a extends outwardly from the longitudinal axis A1 at the conical angle a. The inner surface 50b is defined by a variable radius R1 measured from the longitudinal axis A1. The outer surface 50a is defined by a variable radius R2 measured from the longitudinal axis A1. A difference X between the variable radius R2 and the variable radius R1 at any particular point along the longitudinal axis A1 is constant over at least a part of the first portion 50 of the plunger body 46. Due to this geometry, the area of the cross-sectional projection is sufficiently large at all points along the axis A1 to avoid magnetic saturation of the plunger body 46.

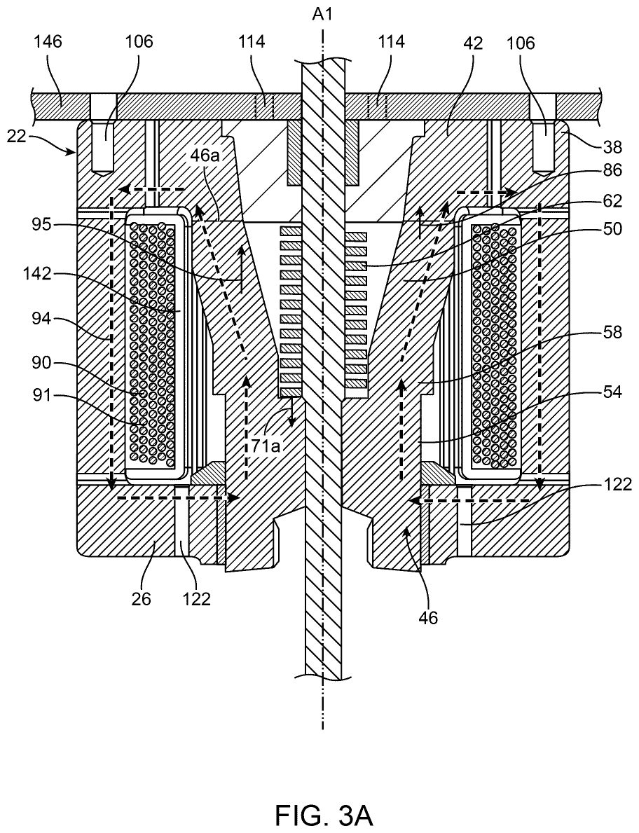

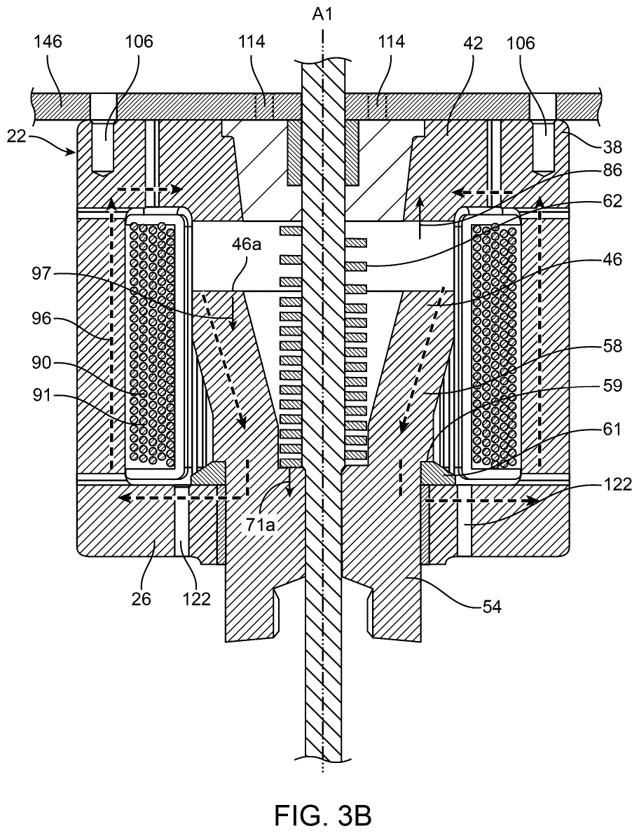

The plunger body 46 and the shaft 34 together form a plunger assembly 60 that is movable relative to the stator 14 between a first position (shown in FIG. 3A) corresponding to the closed position of the moveable contact, and a second position (shown in FIG. 3B) corresponding to the open position of the movable contact. As described in greater detail below, the contoured shape of the plunger body 46 reduces the mass of the plunger body 46 compared to, for example, a completely cylindrical plunger body. In the illustrated embodiment, the plunger body 46 advantageously has a mass that is less than 1 kg, such that the plunger body 46 has a relatively low inertia and can accelerate quickly, thereby resulting in faster movement of the movable contact and reduced arcing between the movable contact and the fixed contact. The contoured shape of the plunger body 46 may also advantageously minimize magnetic field energy losses and avoid saturation.

In the first (contacts closed) position of the plunger assembly 60 (FIG. 3A), the first end 46a of the plunger body 46 abuts the first end cap 22 and, more specifically, the inner portion 42 of the first end cap 22. In the second (contacts open) position of the plunger assembly 60 (FIG. 3B), the first end 46a of the plunger body 46 is spaced from the first end cap 22, and the lip 59 of the plunger body 46 abuts a washer 61 supported by the second end cap 26. Referring again to FIG. 2, a spring 62 is positioned within the recess 51 of the plunger body 46 to bias the plunger body 46 away from the first end cap 22 and toward the second position (i.e., the spring 62 exerts a downward spring force 71a against the plunger body 46. The spring 62 includes a first end 66 seated against the bearing support 30 and a second end 70 seated against a bottom end of the recess 51. The spring 62 may have a relatively high spring constant of (e.g., between 30 and 40 N/mm in some embodiments). In some embodiments, the spring 62 may be formed of a wire with a square or rectangular cross-section, which may contribute to the high spring constant

With continued reference to FIG. 2, a plurality of permanent magnets 74 is supported by the first end cap 22, between the outer portion 38 and the inner portion 42 of the first end cap 22. The magnets 74 may include, for example, neodymium or other rare earth materials. The magnets 74 are circumferentially positioned about the longitudinal axis A1 in a generally octagonal shape. The magnets 74 generate a magnetic field extending through the inner portion 42 of the first end cap 22 and into the plunger body 46 when the plunger assembly 60 is in its first position, developing a magnetic attractive force 86 that retains the plunger assembly 60 in the first position against the spring force 71a . That is, the magnetic attractive force 86 is greater in magnitude than the spring force 71a in some embodiments, or at least greater than a sum of the spring force 71a and any gravitational force acting in the direction of the spring force 71a (e.g., the weight of the plunger assembly 60).

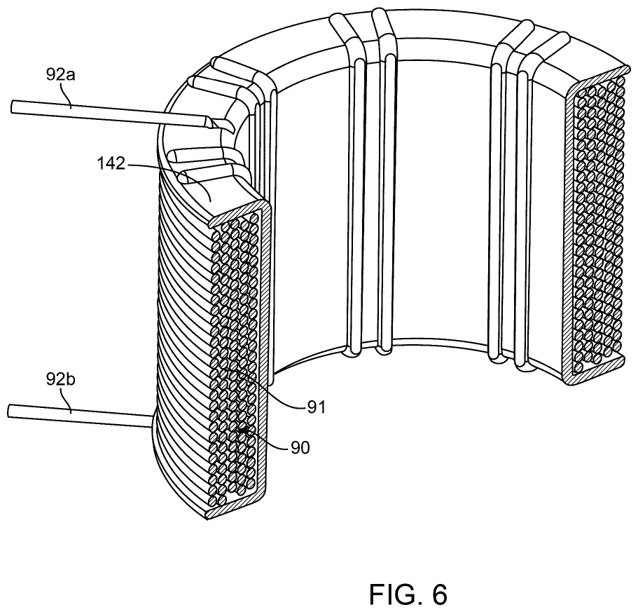

With reference to FIGS. 2 and 6, a main coil 90 is positioned around the plunger body 46. The main coil 90 is partially surrounded by a coil frame 142. In the illustrated embodiment, the main coil 90 is surrounded on three sides by the coil frame 142, such that the coil frame 142 has a U-shaped cross-section. The coil frame 142 is positioned between the main coil 90 and the plunger body 46, between the main coil 90 and the first end cap 22, and between the main coil 90 and the second end cap 26. The main coil 90 includes a wire 91 wrapped continuously around the coil frame 142 to a thickness, for example, of five layers of wire 91 in the illustrated embodiment. In other embodiments, different numbers of layers of wire 91 may be used. The illustrated wire 91 is made of a conductive material, such as copper. Free ends 92a, 92b (FIG. 6) of the wire 91 are electrically connected to a current source. The configuration of the main coil 90 may provide a relatively low inductance, permitting a rapid increase in current driven through the coil 90. This may result in the magnetic actuator 10 having a faster operating speed than typical magnetic actuators.

With reference to FIG. 3B, the main coil 90 may be selectively energized (i.e., by directing current through the wire 91 in a first direction) to generate a first magnetic field 96 that forms a loop around the main coil 90, represented by the dashed arrows surrounding the main coil 90 in FIG. 3B. The first magnetic field 96 generates a downwardly directed magnetic force 97 on the plunger body 46. The magnetic force 97 acts in an opposite direction to the magnetic attractive force 86 produced by the permanent magnets 74. The magnetic force 97 and the spring force 71a operate together to counteract and overcome the magnetic attractive force 86, thereby moving the plunger body 46 downwardly from the first (contacts closed) position (FIG. 3A) to the second (contacts open) position (FIG. 3B).

Referring to FIG. 3A, the main coil 90 may also be selectively energized (i.e., by directing current through the wire 91 in a second direction opposite the first direction) to generate a second magnetic field 94 that forms a loop around the main coil 90, represented by the dashed arrows surrounding the main coil 90 in FIG. 3A. The second magnetic field 94 generates an upwardly directed magnetic force 95 on the plunger body 46. The magnetic force 95 acts in a direction opposite the spring force 71a and is sufficient to overcome the spring force 71a (when the spring 62 is in its expanded state corresponding with the second position of the plunger assembly 60) to move the plunger assembly 60 from the second (contacts open) position (FIG. 3B) toward the first (contacts closed) position (FIG. 3A). As the plunger assembly 60 approaches the first position, the magnetic attractive force 86 grows stronger. Once the plunger assembly 60 reaches the first position (FIG. 3A), the magnetic attractive force 86 is sufficient to maintain the plunger assembly 60 in the first position, and the main coil 90 may be de-energized.

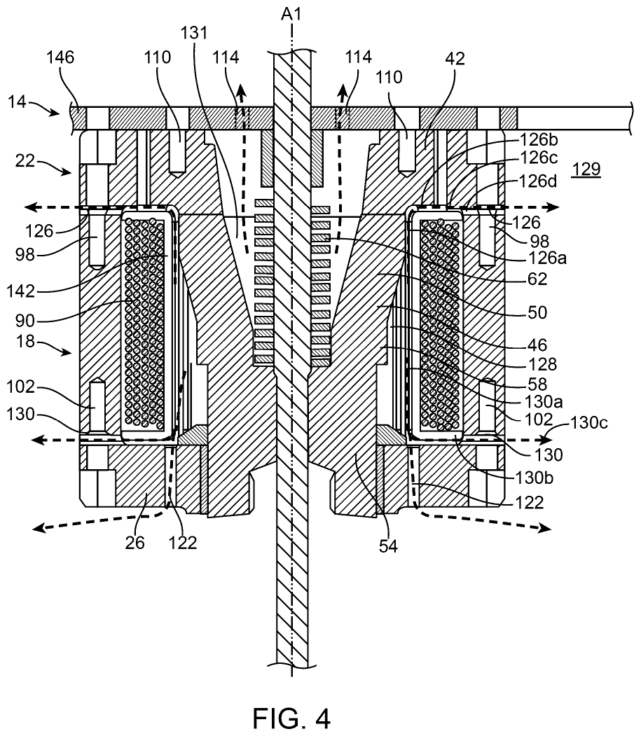

With reference to FIG. 4, the stator 14 includes a plurality of bores to facilitate assembly of the stator 14. In particular, the stator 14 includes a first plurality of bores 98 extending between the frame 18 and the outer portion 38 of the first end cap 22. The first plurality of bores 98 is configured to receive a first plurality of fasteners (not shown) to attach the outer portion 38 of the first end cap 22 to the frame 18. A second plurality of bores 102 extends between the frame 18 and the second end cap 26. The second plurality of bores 102 is configured to receive a second plurality of fasteners (not shown) to attach the second end cap 26 to the frame 18. With returning reference to FIG. 3A, a third plurality of bores 106 extends between an end plate 146 and the outer portion 38 of the first end cap 22. The third plurality of bores 106 is configured to receive a third plurality of fasteners (not shown) to attach the end plate 146 to the outer portion 38 of the first end cap 22. With returning reference to FIG. 4, a fourth plurality of bores 110 extends between the end plate 146 and the inner portion 42 of the first end cap 22. The fourth plurality of bores 110 is configured to receive a fourth plurality of fasteners (not shown) to attach the end plate 146 to the inner portion 42 of the first end cap 22.

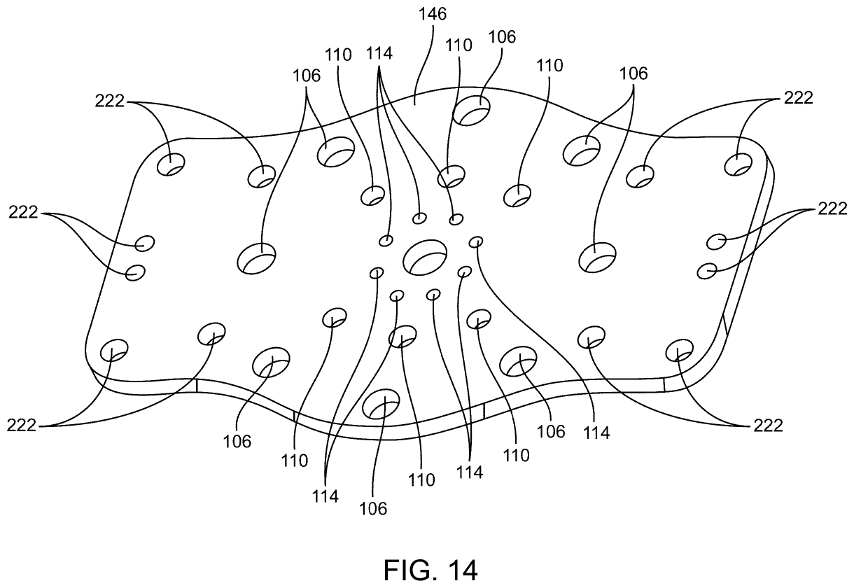

With reference to FIG. 14, the end plate 146 includes a plurality of mounting bores 222 positioned around the end plate 146 for mounting the end plate 146, and accordingly the magnetic actuator 10, to an enclosure of a switchgear system.

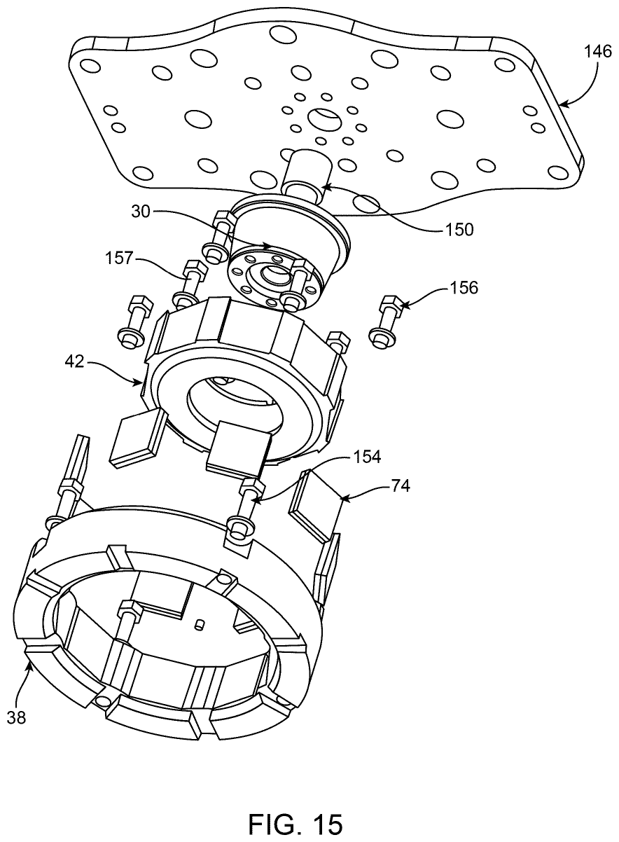

With reference to FIG. 15, a plurality of fasteners 154 fasten the outer portion 38 of the first end cap 22 to the frame 18. Another plurality of fasteners 156 extend between the end plate 146 and the outer portion 38 of the first end cap 22. Yet another plurality of fasteners 157 extend between the end plate 146 and the inner portion 42 of the first end cap 22. The fasteners 154, 156, 157 function together to hold the first end cap 22 to the end plate 146, to support the bearing support 30, and to support the outer portion 38 and the inner portion 42 of the first end cap such that the magnets 74 are supported between the outer portion 38 and the inner portion 42.

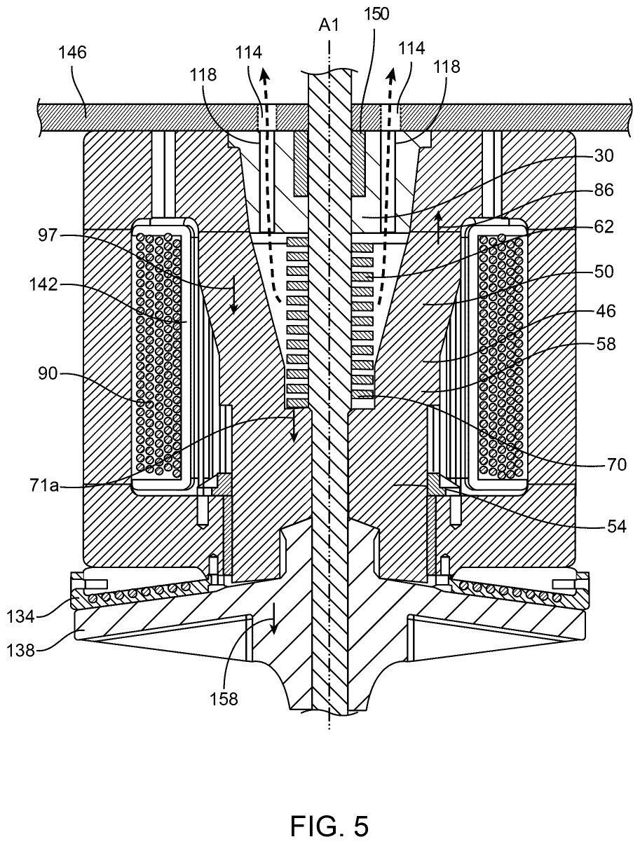

The illustrated stator 14 may also include a plurality of bores that define air vents to control the movement speed of the plunger assembly 60. For example, with reference to FIGS. 4 and 5, a first plurality of air vents 114 is provided in the end plate 146. The first plurality of air vents 114 may be oriented axially (i.e., parallel to the longitudinal axis A1). A second plurality of air vents 118 is provided in the bearing support 30. The second plurality of air vents 118 may also be oriented axially. A third plurality of air vents 122 is provided in the second end cap 26. The third plurality of air vents 122 may also be oriented axially.

A first plurality of lateral air vents 126 is provided perpendicular the longitudinal axis A1 to vent a first internal cavity 128 between the plunger body 46 and the coil frame 142 to an atmosphere 129. Each of the first plurality of lateral air vents 126 includes a first portion 126a between the plunger body 46 and the coil frame 142, a second portion 126b between the inner portion 42 and the coil frame 142, a third portion 126c between the coil frame 142 and the outer portion 38, and a fourth portion 126d between the frame 18 and the outer portion 38. A second plurality of lateral air vents 130 is provided perpendicular to the longitudinal axis A1 to vent the first internal cavity 128 to the atmosphere 129. Each of the second plurality of lateral air vents 130 includes a first portion 130a between the plunger body 46 and the coil frame 142, a second portion 130b between the coil frame 142 and the second end cap 26, and a third portion 130c between the frame 18 and the second end cap 26. The third plurality of air vents 122 may also vent the first internal cavity 128 to the atmosphere 129. The first and second pluralities of air vents 114, 118 may vent a second internal cavity 131, provided within the conical first portion 50 of the plunger body 46, to the atmosphere 129.

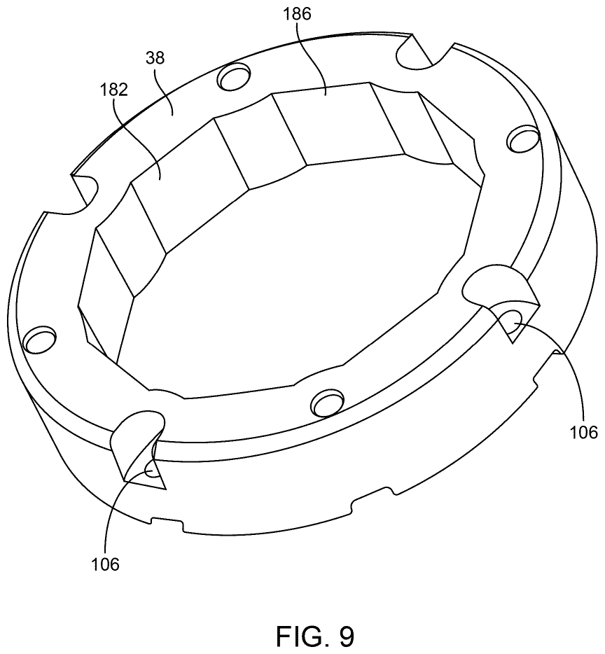

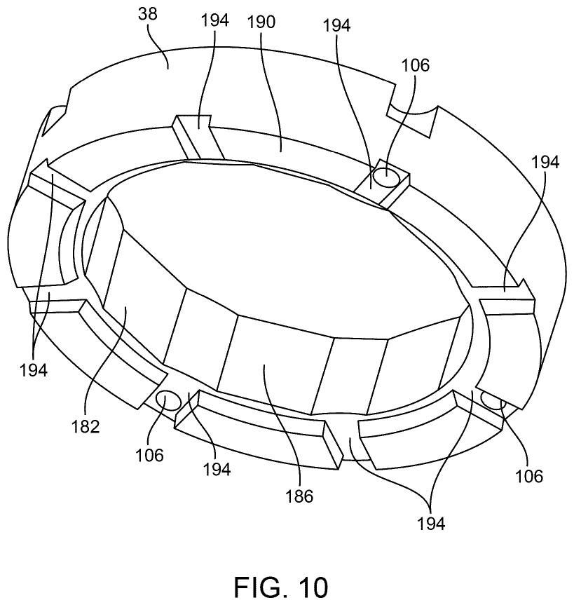

With reference to FIGS. 9 and 10, the outer portion 38 of the first end cap 22 includes an inside surface 182 having a plurality of flat surfaces 186 that sandwich the magnets 74 between the outer portion 38 and the inner portion 42. The outer portion 38 includes a lower surface 190 including a plurality of radial channels 194 spaced about the outer portion 38. Each of the channels 194 forms and/or partially defines part of one of the first plurality of lateral air vents 126. In the illustrated embodiment, each of the channels 194 forms part of the fourth portion 126d of one of the first plurality of lateral air vents 126. The channels 194 are cut into the lower surface 190 and equidistantly spaced about the outer portion 38 of the first end cap 22.

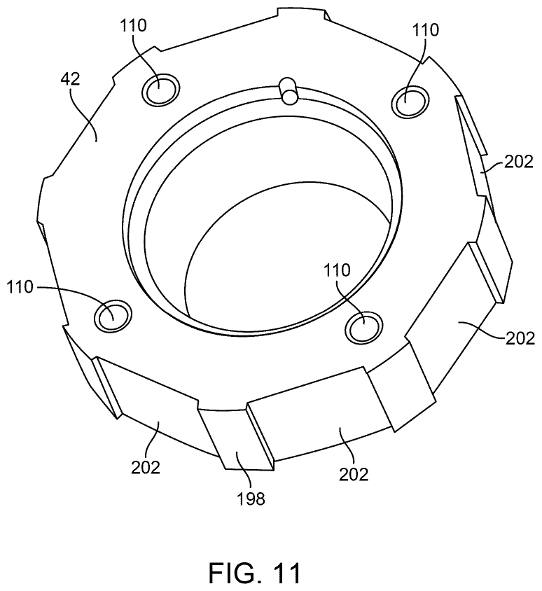

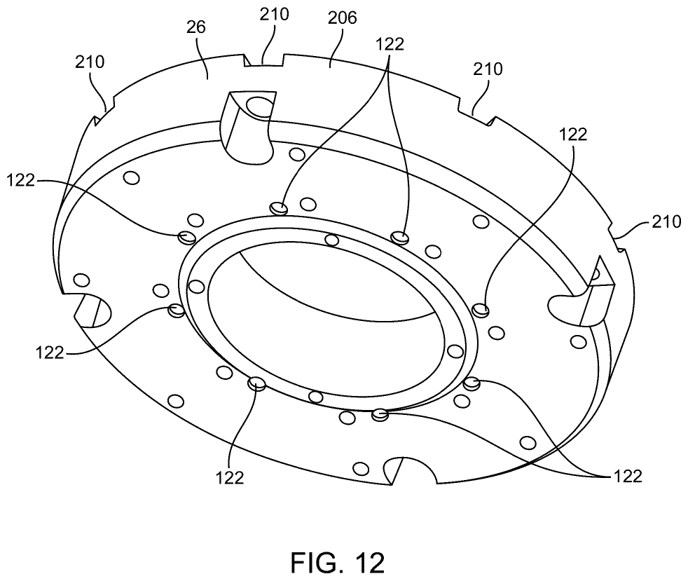

With reference to FIG. 11, the inner portion 42 of the first end cap 22 includes an outer surface 198 having a plurality of flat surfaces 202 that sandwich the magnets 74 between the outer portion 38 and the inner portion 42. With reference to FIG. 12, the second end cap 26 includes an upper surface 206 including a plurality of radial channels 210 spaced about the second end cap 26. Each of the channels 210 forms part of one of the second plurality of lateral air vents 130. In the illustrated embodiment, each of the channels 210 forms part of the third portion 130c of one of the second plurality of lateral air vents 130.

As shown in FIG. 4, the air vents allow air displaced by movement of the plunger assembly 60 to escape from between the plunger assembly 60 and the stator 14. The air vents may also act as restrictive orifices to dampen movement of the plunger assembly 60 and reduce the force of the impact between the plunger assembly 60 and the stator 14 when the plunger assembly 60 reaches the first position and the second position.

With reference to FIG. 5, the magnetic actuator 10 may further include a secondary coil 134 is affixed to the stator 14 and more specifically to the second end cap 26. The secondary coil 134 is a Thomson coil 134 in the illustrated embodiment, and is electrically connected to a current source. The current source may be the same current source or a different current source than the current source electrically connected to the main coil 90. However, the current directed through the Thomson coil 134 may be greater in magnitude than the current directed through the main coil 90. For example, in some embodiments, the main coil 90 may be configured to receive 30-100 Amps of current during operation, and the Thomson coil 134 may be configured to receive more than 1,000 Amps of current during operation. A disk 138, (i.e., a Thomson disk), is affixed (e.g., by press-fitting, welding, etc.) to the plunger body 46 and/or to the shaft 34 for longitudinal motion therewith. As such, the disk 138 may be part of the plunger assembly 60.

Energizing the secondary coil 134 produces a magnetic force 158 that acts to separate the disk 138 from the secondary coil 134. The magnetic force 158 cooperates with the spring force 71a and the magnetic force 97 to overcome the magnetic attractive force 86 and to move the plunger assembly 60 from the first position (FIGS. 5 and 3A) to the second position (FIG. 3B), resulting in faster acceleration of the plunger assembly 60. A method of operating the magnetic actuator 10 may include energizing the main coil 90 and the secondary coil 134 simultaneously. In other embodiments, the secondary coil 134 may be energized slightly before the main coil 90 is energized, or vise-versa.

Thus, the present disclosure provides, among other things, a magnetic actuator that may be able to provide a faster actuating speed than known magnetic actuators. For example, in some embodiments, the magnetic actuator 10 provides at least 1.0 cm of travel along the axis A1 in 6 milliseconds or less. In some embodiments, the magnetic actuator 10 may provide at least 1.0 cm of travel along the axis A1 in 5 milliseconds or less. In some embodiments, the magnetic actuator 10 may provide at least 1.0 cm of travel along the axis A1 in 4 milliseconds or less. These fast actuating speeds, achieved by the constructions of the magnetic actuator 10 described and illustrated herein, may reduce arcing that occurs when the contacts are separated.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A magnetic actuator for a switchgear system, the magnetic actuator comprising:
a stator supporting a plurality of permanent magnets and a coil; and
a plunger assembly movable along an axis relative to the stator between a first position and a second position in response to energizing the coil,
wherein the plunger assembly is configured to move at least 1.0 cm along the axis between the first position and the second position in 6 ms or less in response to energizing the coil.

2. The magnetic actuator of claim 1, wherein the stator includes a cylindrical frame.

3. The magnetic actuator of claim 1, wherein the plunger assembly includes a shaft extending along the axis and a plunger body fixed to the shaft, and wherein the plunger body has a mass less than 1 kg.

4. The magnetic actuator of claim 3, wherein the plunger body includes a tapered portion.

5. The magnetic actuator of claim 4, wherein the plunger body includes a first end, a second end opposite the first end, a first portion extending from the first end, and a second portion extending from the second end, wherein the first portion includes the tapered portion, and wherein the second portion is cylindrical.

6. The magnetic actuator of claim 5, wherein the plunger body includes a third portion between the first portion and the second portion, wherein the third portion is cylindrical, and wherein an outer diameter of the third portion is greater than an outer diameter of the second portion to define a lip.

7. The magnetic actuator of claim 6, wherein the first end of the plunger body engages the stator when the plunger assembly is in the first position, and wherein the lip engages the stator when the plunger assembly is in the second position.

8. The magnetic actuator of claim 1, further comprising a spring biasing the plunger assembly toward the second position.

9. The magnetic actuator of claim 8, wherein the spring has a spring constant of at least 30 N/mm.

10. The magnetic actuator of claim 8, wherein the plunger assembly includes a plunger body having a recess, and wherein the spring is received within the recess.

11. The magnetic actuator of claim 10, wherein the recess is tapered.

12. The magnetic actuator of claim 1, wherein the stator includes a frame surrounding the coil, and wherein the frame is cylindrical.

13. The magnetic actuator of claim 1, wherein the coil is a first coil, and wherein the magnetic actuator further comprises a second coil supported by the stator.

14. The magnetic actuator of claim 13, further comprising a spring biasing the plunger assembly in a first direction toward the second position, and wherein the second coil is configured to be energized to produce a force on the plunger assembly in the first direction.

15. The magnetic actuator of claim 14, wherein the first coil and the second coil are configured to be energized to move the plunger assembly from the first position toward the second position.

16. The magnetic actuator of claim 15, wherein the plurality of permanent magnets is configured to retain the plunger assembly in the first position.

17. A magnetic actuator for a switchgear system, the magnetic actuator comprising:
a stator supporting a plurality of permanent magnets and a coil;
a plunger assembly movable along an axis relative to the stator between a first position and a second position in response to energizing the coil, wherein the plunger assembly includes a shaft extending along the axis and a plunger body fixed to the shaft, the plunger body including
a first end,
a second end opposite the first end,
a first portion extending from the first end, the first portion having a tapered shape,
a second portion extending from the second end, the second portion having a cylindrical shape, and
a third portion between the first portion and the second portion, wherein the third portion is cylindrical, and wherein an outer diameter of the third portion is greater than an outer diameter of the second portion to define a lip;
a spring biasing the plunger assembly in a first direction toward the second position; and
a permanent magnet configured to retain the plunger assembly in the first position,
wherein the first end of the plunger body engages the stator when the plunger assembly is in the first position, and
wherein the lip engages the stator when the plunger assembly is in the second position.

18. A magnetic actuator for a switchgear system, the magnetic actuator comprising:
a stator supporting a plurality of permanent magnets, a first coil, and a second coil;
a plunger assembly movable along an axis relative to the stator from a first position toward a second position in response to energizing the first coil and the second coil; and
a spring configured to bias the plunger assembly toward the second position,
wherein the plurality of permanent magnets is configured to retain the plunger assembly in the first position via a magnetic attractive force greater than a biasing force of the spring, and
wherein the first coil and the second coil, when energized, produce magnetic forces on the plunger assembly, which, together with the biasing force of the spring, overcome the magnetic attractive force to move the plunger assembly to the second position.

19. The magnetic actuator of claim 18, wherein the stator includes a frame surrounding the first coil, and wherein the frame is cylindrical.

20. The magnetic actuator of claim 19, further comprising a first end cap coupled to the frame and a second end cap coupled to the frame opposite the first end cap, wherein the second end cap is positioned between the frame and the second end cap.
